(19) United States
(12) Patent Application Publication
(10) Pub. No.: US 2016/0192417 A1
(43) Pub. Date: Jun. 30, 2016

(54) Systems and Methods of Wireless USB Service Discovery

(71) Applicant: Texas Instruments Incorporated, Dallas, TX (US)

(72) Inventors: Leonardo William Estevez, Rowlett, TX (US); Assaf Sella, Rishpon (IL); Benzy Gabay, Plano, TX (US)

(73) Assignee: TEXAS INSTRUMENTS INCORPORATED, Dallas, TX (US)

(21) Appl. No.: 14/583,529

(22) Filed: Dec. 26, 2014

(51) Int. Cl. H04W 76/02; G06F 13/38; H04L 29/06; G06F 13/42

(52) U.S. Cl. CPC H04W 76/023; H04W 76/028; G06F 13/4282; G06F 13/387; H04L 63/0876

(57) ABSTRACT

Example embodiments of the systems and methods of wireless USB service discovery disclosed herein provide the querying of the MAC address of devices for available services to determine the information elements provided to the querying devices based on access categories specified by the user of the querying device. Sniffing or querying of the Wi-Fi enabled devices may subsequently determine which of the MAC addresses correspond to known friends and automatically make that content accessible to those friends by including these MAC addresses in file metadata so that a device with this MAC address can subsequently access the file. Availability of this file for download may subsequently be advertised.

### TECHNICAL FIELD

The present disclosure is generally related to networking and, more particularly, is related to wireless connectivity.

### BACKGROUND

A Wireless USB (WUSB) is a Universal Serial Bus (USB) built on ultra-wideband (UWB) technology, which uses a radio frequency (RF) link, rather than cables, to transfer information between compatible USB devices. WUSB enables 127-point connections with compatible devices and has a signal radius of three to 10 meters, with signal strength ranging from 480 to 110 Mbps. Security may be ensured via transmission encryption. Key WUSB features include Plug and Play (PnP) compatibility and hot swapping with other devices, compatibility with earlier USB versions, host capability, which may be used with a PC through a Host Wire Adapter (HWA) that connects to a USB port or the MiniCard Interface, and support of a dual-role device (DRD), which works as a WUSB device, as well as a host with several features.

Wireless USB may be used in game controllers, printers, scanners, digital cameras, portable media players, hard disk drives and flash drives, among other devices. It is also suitable for transferring parallel video streams, using USB over ultra-wideband protocols.

The WUSB architecture allows up to 127 devices to connect directly to a host. Because there are no wires or ports, there is no longer a need for hubs. However, to facilitate migration from wired to wireless, WUSB introduced a new Device Wire Adapter (DWA) class. Sometimes referred to as a “WUSB hub”, a DWA allows existing USB 2.0 devices to be used wirelessly with a WUSB host.

WUSB host capability may be added to existing PCs through the use of a Host Wire Adapter (HWA). The HWA is a USB 2.0 device that attaches externally to a desktop or laptop's USB port or internally to a laptop's MiniCard interface.

WUSB also supports dual-role devices (DRDs), which in addition to being a WUSB device, can function as a host with limited capabilities. For example, a digital camera could act as a device when connected to a computer and as a host when transferring pictures directly to a printer.

UWB is a general term for radio communication using pulses of energy which spread emitted Radio Frequency (RF) energy over 500 MHz+ of spectrum or exceeding 20% fractional bandwidth within the frequency range of 3.1 GHz to 10.6 GHz as defined by the FCC ruling issued for UWB in February 2002. WUSB is a protocol promulgated by the USB Implementers Forum that uses the UWB radio platform. Other protocols that have announced their intention to use UWB radio platform include Bluetooth and the WiMedia Logical Link Control Protocol.

A few issues differentiate Wireless USB from the use of the 60 GHz band as promoted by the Wireless Gigabit Alliance: such as line of sight and mobility. At 60 GHz, radio communication is blocked by any intervening object, which implies the need for open line of sight. Wireless USB is based on the Ultra-WideBand (UWB) platform, which operates in the 3.1 to 10.6 GHz frequency range, and thus can pass through intervening bodies.

The 60 GHz technology is appealing to the wireless video market because it is supposed to deliver multi-gigabit-speed wireless communications. In order to support such heavy demands, the underlying MAC layer should be able to process this huge amount of data. For these requirements, the 60 GHz-based products need higher power consumption, and more electronics, which are less suitable for mobile units or devices.

### SUMMARY

Example embodiments of the present disclosure provide systems of wireless USB service discovery. Briefly described, in architecture, one example embodiment of the system, among others, can be implemented as follows: a semiconductor integrated circuit configured to perform wireless USB communications; and memory for storing software comprising instructions for: enabling file sharing over wireless serial bus by a first wireless device (WSB1); receiving a connection request from a second wireless device (WSB2); transmitting shareable files to WSB2 upon request from WSB1; logging the MAC address of the WSB2 and the connection time; receiving a reconnection request from WSB2; denying the reconnection request if no shareable files have later timestamps than the most recent connection time of WSB2; and allowing the reconnection request if at least one shareable file has a later timestamp than the most recent connection time of WSB2.

Embodiments of the present disclosure can also be viewed as providing methods for wireless USB service discovery. In this regard, one embodiment of such a method, among others, can be broadly summarized by the following steps: a first device (WSB1) connecting to a second device (WSB2) wirelessly over a wireless serial bus; WSB1 logging the MAC address of WSB2 and a time stamp of the connection; and WSB1 sending at least one file that has a later logged time stamp than a most previous logged connection time stamp.

### BRIEF DESCRIPTION OF THE DRAWINGS

FIG. 1 is a block diagram of an example embodiment of a system of wireless USB service discovery.

FIG. 2 is a block diagram of an example embodiment of a device for use in the system of FIG. 1.

FIG. 3 is a signal diagram of an example embodiment of a method of wireless USB service discovery.

FIG. 4 is a flow diagram of an example embodiment of the method of FIG. 3.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Example embodiments of the systems and methods of wireless USB service discovery disclosed herein provide the querying of the MAC address of devices for available services to determine the information elements provided to the querying devices based on access categories specified by the user of the querying device. Sniffing or querying of the Wi-Fi enabled devices may subsequently determine which of the MAC addresses correspond to known friends and automatically make that content accessible to those friends by including these MAC addresses in file metadata so that a device with this MAC address can subsequently access the file. Availability of this file for download may subsequently be advertised.

Example embodiments of the systems and methods disclosed herein are implemented such that a service (for example, a mass storage USB device class) is advertised to devices of interest to make them aware that there is content available for them on another device. This content may be automatically tagged for sharing with devices having specific MAC addresses. Alternatively, the content may be tagged for sharing based on user assigned access to a given peripheral or file system directory with an associated MAC address. The user of the device may associate file system directories (which may be shared as a USB mass storage device) or other peripheral devices (for example, USB audio or video device) for access by another device based on its MAC address.

Access security may be established for a given file, directory, or peripheral by the type of connection required. Access to content on an enterprise device, for example, may require an IP connection with enhanced higher layer security (such as SSL). Other access to files may rely on Wi-Fi direct WPS PBC for security and bypass the IP stack to enable faster transfers. The discoverable state of a device may be reset through Wi-Fi direct enablement/disablement through the user interface or through an application.

Service discovery in wireless USB may occur regularly, draining the battery life with every discovery request. However, if neither side has any updates to transmit, then any discovery request/response is wasteful. If a file is changed or has been updated, then it should be made discoverable so that a user's local version of the file can be refreshed. If a file has not been changed on another device, for example, with media sharing, since the last connection, then there is no need to connect. There is no need to connect to the other user to view new pictures because the user already has them. Unwarranted connection would be a waste of time, resources, and battery life to connect the devices.

In an example embodiment, the discovery mechanism for the Wi-Fi serial bus follows a determination of whether there has been any change to any of the files that have been made available between users. If the files that were made available for sharing have changed, then the first user makes itself discoverable to the second user so that a connection is made between the two users to transmit new files or updated files. Otherwise, if there has been no change since the last connection between the users, the user (device) does not make itself discoverable.

Previously, to determine if another device has shared files that can be updated, a connection would first be made over Wi-Fi. In example embodiments of the systems and methods of wireless USB service discovery disclosed herein, the device does not make itself available to the other device until there has been a change in a shareable file. In an example embodiment, the first device takes a time stamp of the last connection between the two devices. If the time stamp of any shareable file on the first device is later than the last connection time stamp, then the first device will make itself available for connection to the second device. However, if there are no changes to the time stamp, or if there are no later time stamps for any shareable file since the last connection time stamp, then the device does not make itself available for connection to the second device.

In an example implementation, if a first device takes a picture, then that picture gets stored in the shared file system of that device. Since the first device has this file with a later time stamp than the time stamp of the last connection with the second device, the first device makes itself available for connection. For example, the second device may receive a pop up message that says “Do you want to connect and get this picture?” If the user of the second device clicks okay, the file is transferred and the connection time stamp is recorded.

A first device may record connection time stamps for several other devices through the discovery process. The first device may selectively make itself discoverable to other devices that haven't connected with the first device since shareable files have been updated. For example, a user attends a social function with friends and takes several pictures. The user's device makes itself discoverable to those friends since it has files with newer timestamps and the picture files are transferred. Then a new friend arrives and the device recognizes that the time stamps on the pictures are newer than the last connection with the new friend, so the first device makes itself discoverable to the new friend. In this case the friends that already had the pictures are not triggered to connect; only the device of the new friend is triggered.

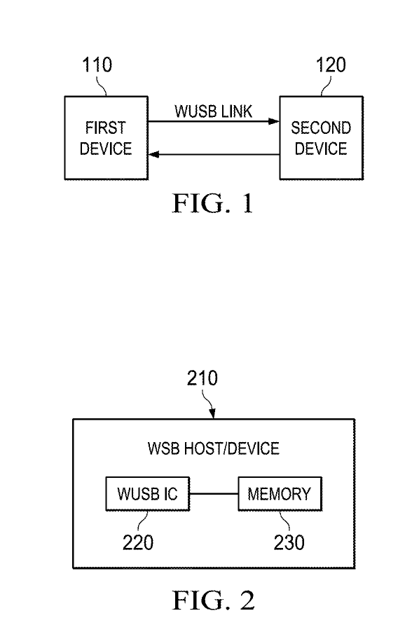

FIG. 1 provides an example embodiment of a wireless USB connection system connecting first device 110 with second device 120. First device 110 may have files saved in memory that are shareable. In an example embodiment, each of these shareable files has a time stamp related to the last time that the file was updated. In an alternative embodiment, some files may not have a time stamp and are not considered shareable. Other files may have a time stamp of a date in the future (for example, 1/1/3014) such that it will always be transferred regardless of any actual updating of the file. In another example embodiment, the shareable files are not saved on the device, but are saved to the cloud and accessible through the device. In yet another embodiment, shareable files are saved to the cloud and only a list of sharable files is saved on the first device. In this embodiment, the second device may access the files directly from the cloud as well, or instead of, through the first device.

FIG. 2 provides an example embodiment of device 210 using the wireless USB service discovery methods described herein as either as a host device or as a dock device. Device 210 includes at least WUSB integrated circuit (IC) 220 and memory 230. Memory 230 stores the software that WUSB IC 220 runs to perform the disclosed methods of wireless USB service discovery. With device 210 as a host device, another wireless USB device may connect to other wireless USB devices through device 210. If device 210 is a dock device, it may only connect to one other wireless USB devices, and no devices can be connected through it.

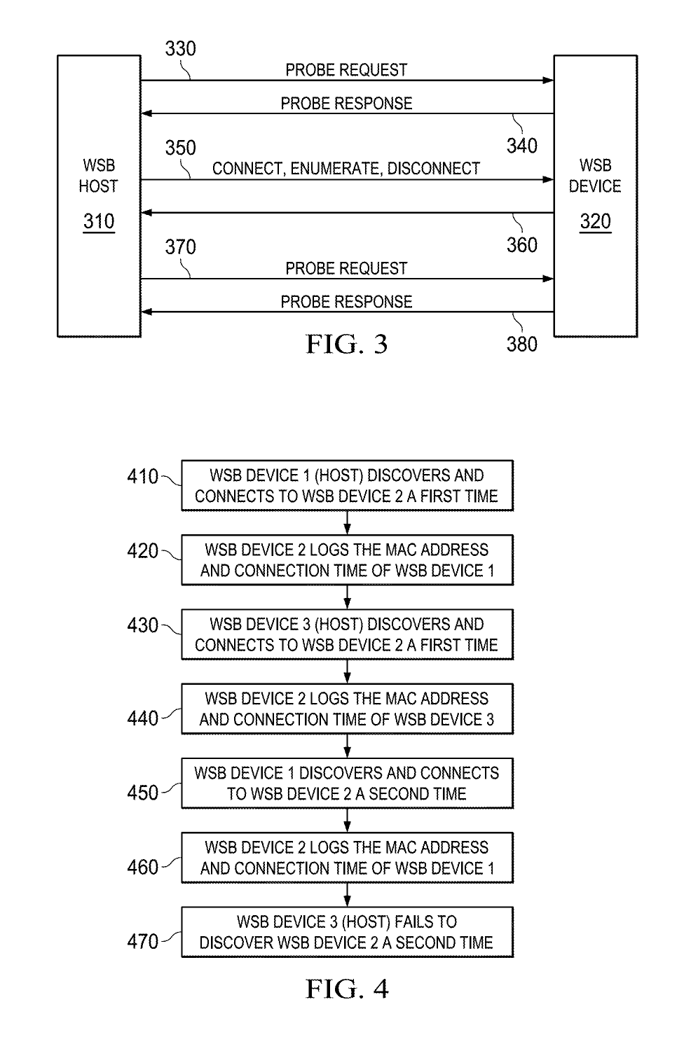

FIG. 3 provides an example embodiment of WUSB host 310 interfacing with WUSB device 320 using the disclosed systems and methods. WSB host 310 sends probe request 330 to WSB device 320. WSB device 320 sends probe response 340 back to WSB host 310. WSB host 310 connects to WSB device 320 in interaction 350. WSB device 320 sends the MAC address of a picture transfer protocol (PTP) device in interaction 360 and WSB host 310 disconnects.

FIG. 4 provides an example embodiment of a method of wireless USB service discovery as disclosed herein. In block, 410, WSB device 1 (Host) discovers and connects to WSB device 2 for a first time. In block 420, WSB device 2 logs the MAC address and connection time of WSB device 1. In block 430, WSB device 3 (Host) discovers and connects to WSB device 2 a first time. In block 440, WSB device 2 logs the MAC address and connection time of WSB device 3. In block 450, WSB device 1 discovers and connects to WSB device 2 a second time. In block 460, WSB device 2 logs the MAC address and connection time of WSB device 1. In block 470, WSB device 3 (Host) fails to discover WSB device a second time. This failure to discover is due to WSB device 2's lack of shareable files with timestamps later than the previous connection time stamp of WSB device 3.

In an example implementation, a user launches a camera application on her cellular phone which turns on WSB/Wi-Fi Direct photo sharing and enables MAC connection time entry override. An alternative implementation may be performed on a digital camera. A second WSB user connects, accesses shareable files, and disconnects. The WSB driver of the second user's device logs the MAC address and the connection time. When the second use attempts to reconnect to the device of the first user, the connection is denied because the time stamp of his MAC address is more recent than the file folder times. The mobile user then takes a picture which causes a new file to be created and a time stamp (for the file or the folder) to be updated. The second mobile user then sends another discovery request and can now connect because a relevant time stamp is more recent. The MAC connection time stamp entry is then updated.

The flow chart of FIG. 4 shows the architecture, functionality, and operation of a possible implementation of the WUSB service discovery software. In this regard, each block represents a module, segment, or portion of code, which comprises one or more executable instructions for implementing the specified logical function(s). It should also be noted that in some alternative implementations, the functions noted in the blocks may occur out of the order noted in FIG. 4. For example, two blocks shown in succession in FIG. 4 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

Therefore, at least the following is claimed:

1. A method comprising:
connecting by a first device (WSB1) to a second device (WSB2) wirelessly over a wireless serial bus;
logging by WSB1 the MAC address of WSB2 and a time stamp of the connection; and
sending by WSB1 at least one file that has a later logged time stamp than a most previous logged connection time stamp.

2. The method of claim 1, including:
reconnecting by WSB1 to WSB2 over the wireless serial bus;
logging by WSB1 the MAC address of WSB2 and the time stamp of the connection; and
sending by WSB1 at least one file that has a later logged time stamp than a most previous logged connection time stamp.

3. The method of claim 1, including:
connecting by WSB1 to a third device (WSB3) over a wireless serial bus;
logging by WSB1 the MAC address of WSB3 and a time stamp of the connection; and
sending by WSB1 at least one file that has a later logged time stamp than a most previous logged connection time stamp.

4. The method of claim 1, in which connecting includes a direct device probe request from WSB1 to WSB2 and a direct probe response from WSB@ to WSB1.

5. The method of claim 4, in which, after receiving the direct device probe request from WSB1, determining by WSB2 if it has files with more recent time stamps than the most recent connection log time and if there are no more recent files, denying by WSB2 the connection request.

6. The method of claim 5, in which WSB2 denies the connection request by not sending a probe response to the probe request.

7. A method, comprising:
enabling file sharing over wireless serial bus by a first wireless device (WSB1);
receiving a connection request from a second wireless device (WSB2);
transmitting shareable files to WSB2 upon request from WSB1;
logging the MAC address of the WSB2 and the connection time;
receiving a reconnection request from WSB2;
denying the reconnection request if no shareable files have later timestamps than the most recent connection time of WSB2; and
allowing the reconnection request if at least one shareable file has a later timestamp than the most recent connection time of WSB2.

8. The method of claim 7, including associating files, file directories, and/or peripheral devices for access by another device based on its MAC address.

9. The method of claim 7, including advertising the availability for download of a newly updated file.

10. The method of claim 9, including saving the MAC address and time stamp in file metadata.

11. The method of claim 10, including requesting security information before enabling access to a file.

12. The method of claim 11, including enabling set/reset of discoverability of a device through a user interface or application.

13. A device comprising:
memory for storing software including instructions for:
enabling file sharing over wireless serial bus by a first wireless device (WSB1);
receiving a connection request from a second wireless device (WSB2);
transmitting shareable files to WSB2 upon request from WSB1;
logging the MAC address of the WSB2 and the connection time;
receiving a reconnection request from WSB2;
denying the reconnection request if no shareable files have later timestamps than the most recent connection time of WSB2; and
allowing the reconnection request if at least one shareable file has a later timestamp than the most recent connection time of WSB2; and
a semiconductor integrated circuit including input/output connections with the memory, the semiconductor integrated circuit configured to perform wireless USB communications using the software stored in the memory.

14. The device of claim 13, in which the memory stores software that includes instructions for associating files, file directories, and/or peripheral devices for access by another device based on its MAC address.

15. The device of claim 13, in which the memory stores software that includes instructions for advertising availability for download of a newly updated file.

16. The device of claim 13, in which the memory stores software that includes instructions for saving the MAC address and time stamp in file metadata.

17. The device of claim 13, in which the memory stores software that includes instructions for requesting security information before access to a file is enabled.

18. The device of claim 13, in which the memory stores software that includes instructions for enabling set/reset of discoverability of a device through a user interface or application.

19. The device of claim 13, in which the device includes a camera.

20. The device of claim 13, in which the device includes a cellular phone.
